(19) United States
(12) Patent Application Publication
(10) Pub. No.: US 2015/0086382 A1
(43) Pub. Date: Mar. 26, 2015

(54) PUMPING SYSTEM CONTROL

(71) Applicant: ABB Oy, Helsinki (FI)

(72) Inventors: Jussi TAMMINEN, Lappeenranta (FI); Tero AHONEN, Lappeenranta (FI); Jero AHOLA, Lappeenranta (FI)

(73) Assignee: ABB Oy, Helsinki (FI)

(21) Appl. No.: 14/489,203

(22) Filed: Sep. 17, 2014

(30) Foreign Application Priority Data
Sep. 26, 2013 (EP) 13186152.8

(51) Int. Cl. G05D 7/06

(52) U.S. Cl. CPC G05D 7/0688
USPC 417/29

(57) ABSTRACT

A method and a control arrangement are disclosed to measure a total flow rate through a pump device before a pump pressure or rotational speed change; and to change at least one of: the pump pressure by a predetermined pressure step or the pump rotational speed by a predetermined rotational speed step. The arrangement can measure a total flow rate through the pump device after the pump pressure or rotational speed change; and determine a need for a further pump pressure or rotational speed change step based on total flow rate measurements carried out before and after the pump pressure change.

### RELATED APPLICATION

This application claims priority under 35 U.S.C. §119 to European Patent Application No. 13186152.8 filed in Europe on Sep. 26, 2013, the entire content of which is hereby incorporated by reference in its entirety.

### FIELD

The present disclosure relates to pump system control, and to a control method and arrangement.

### BACKGROUND INFORMATION

Pumping systems are used in household, industrial and municipal applications. Increased energy consciousness has brought to attention the amount of energy saving potential related to these systems. Variable-speed drives allowing rotational speed control of the pump have been introduced to address the energy efficiency of the pumping system. However, the rotational speed control alone does not ensure an optimal energy efficiency of the system, as the energy efficiency of the pump or an electric motor is not equal to the energy efficiency of the whole system operation.

A pumping system can have the best preconditions for operating energy efficiently when losses are minimized. This may be obtained, for instance, by minimizing flow resistance in a piping system by opening control valves to their maximum and using a smallest pressure that satisfies the system specifications or selecting a rotational speed that results in the lowest specific energy consumption.

Pumping systems having several branches, wherein each branch includes a control valve to control the amount of fluid flowing through the branch are known. It is also known that these systems work energy efficiently when a control valve is opened completely, the pump pressure is controlled according to the flow rate through this valve, and the other valves control the flow rate through their respective branch according to the specification of flow rate with throttling. However, this method involves valve setting or angle information to be retrievable from a control system or from a direct feedback from the valve. This involves additional instrumentation and wiring, increasing the system costs and providing a further source of failure, and in many cases, as in connection with a thermostat-controlled radiator based heating system for example, this information is not available in the first place.

It is also known to minimize the pump pressure specified by constantly changing a proportional pressure curve used in the control of the pump rotational speed, wherein the selection of the control curve is based on hydraulic conductivity and its saturation. The hydraulic conductivity is then calculated from a measured pump pressure and flow rate and the saturation is monitored. In this method, a lower proportional pressure curve is selected if the time distribution of the hydraulic conductivity is for most of the time below a time domain mean value, in other words saturated low, for example. Correspondingly, a higher proportional pressure curve is selected if the hydraulic conductivity is saturated high. In this method, the pump pressure is above the minimal specified pump pressure and, thus, hydraulic losses are not completely minimized, whereby no minimum energy consumption is reached.

### SUMMARY

A method of controlling a pump system is disclosed having a pump device and at least two branches, wherein each of the branches has a flow control element, and a pump device control is provided in connection with the pump device, the method comprising: measuring a total flow rate through the pump device before a pump pressure or rotational speed change; changing at least one of: the pump pressure by a predetermined pressure step or the pump rotational speed by a predetermined rotational speed step; measuring a total flow rate through the pump device after the pump pressure or rotational speed change; and determining a need for a further pump pressure or rotational speed change step based on the total flow rate measurements carried out before and after the pump pressure or rotational speed change.

A control arrangement for a pump system is disclosed having a pump device and at least two branches, wherein each branch has a flow control element, the control arrangement comprising: means for measuring a total flow rate through a pump device, the means for measuring the total flow rate being configured to measure the total flow rate before a pump pressure or rotational speed change and after a pump pressure or rotational speed change; and pump device control means, configured to change, by a predetermined step, at least one of pump pressure or pump rotational speed, the pump device control means being configured to determine a need for a further pump pressure or rotational speed change step based on said total flow rate measurements before and after a pump pressure or rotational speed change.

### BRIEF DESCRIPTION OF THE DRAWINGS

In the following, features and advantages disclosed herein will be described in greater detail by reference to exemplary embodiments, and with reference to the accompanying drawings, in which:

FIG. 1 schematically illustrates an exemplary pump system;

FIG. 2 schematically illustrates an exemplary method of controlling a pump system;

FIG. 3 schematically illustrates an exemplary method of controlling a pump system as a flow chart;

FIGS. 4a and 4b illustrate exemplary pump device characteristic curves;

FIG. 5 schematically illustrates a block set diagram of a pump system control according to an exemplary embodiment;

FIG. 6 schematically illustrates an exemplary arrangement for pump system control;

FIG. 7 schematically illustrates an example of a rotational speed, total flow rate and pressure in connection with a use case of exemplary pump system control; and

FIG. 8 schematically illustrates an exemplary method of controlling a pump system.

### DETAILED DESCRIPTION

A new method and a new arrangement are disclosed for controlling pump systems.

Exemplary embodiments are based on an idea of utilising known and/or determined pump characteristics and easily determined pressure and/or rotational speed of the pump and flow rate information to find and control a pump pressure setting that can optimize the energy efficiency of the system.

An exemplary advantage of a method and arrangement disclosed herein can be that the efficiency of pumping systems having two or more branches, each having an independently adjustable control element, can be significantly improved with no need for information about valve settings or angles. Thus, additional instrumentation and wiring can be avoided.

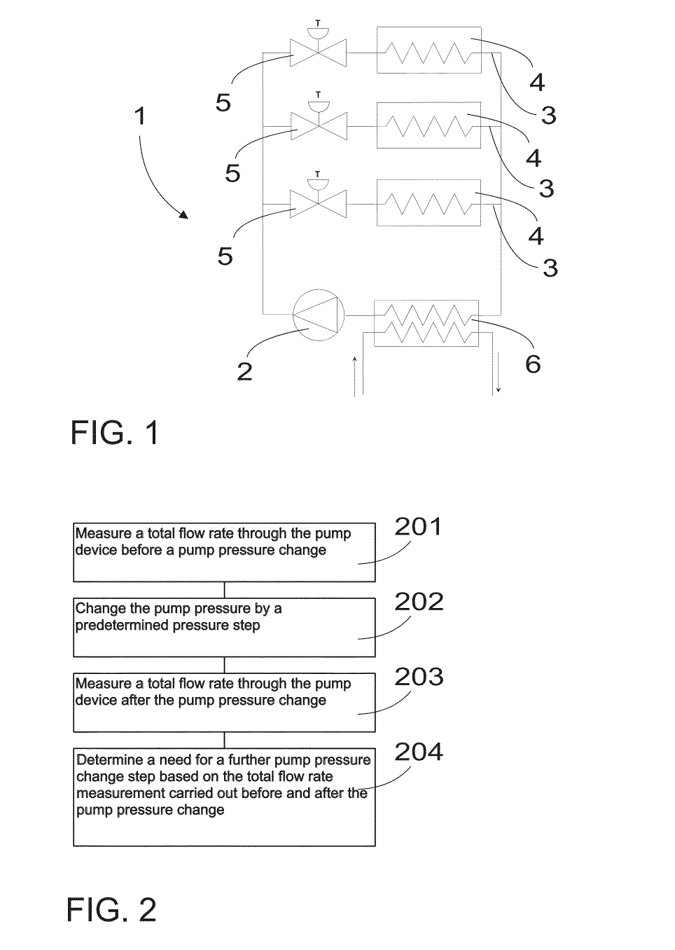

FIG. 1 schematically illustrates an exemplary pump system. The pump system includes a pump device 2 and at least two branches 3. In the exemplary embodiment of FIG. 1, the pump system 1 includes three branches 3. Each of the branches may include a flow control element 5, and pump device control means, such as a variable speed drive, a variable frequency drive, an inlet vane guide and/or a control element, may be provided in connection with the pump device 2.

In the exemplary embodiment of FIG. 1, the pump system 1 includes a heating system, wherein each of the branches 3 includes a load element 4, such as a heating element, and a flow control element 5, such as a thermostat. The pump system can also include a thermal transfer element 6. This embodiment is shown as an example only and it will be clear to those skilled in the art that the configuration of the pump system may vary in different embodiments within in the scope of the claims.

FIG. 2 schematically illustrates an exemplary method of controlling a pump system. In this method, a total flow rate through the pump device is measured 201 before a pump pressure change, the pump pressure is changed 202 by a predetermined pressure step, a total flow rate through the pump device is measured 203 after the pump pressure change, and a desire or need for a further pump pressure change step is determined 204 on the basis of the total flow rate measurement carried out before and after the pump pressure change.

According to an exemplary embodiment, a new pressure change step is only to be started once a sufficient time has elapsed since the previous pressure change step to enable the pump system to reach a steady state again. This time interval for starting a new pressure change step is referred to as an execution time interval and it should be defined separately for each system and embodiment because it can depend on the embodiment and system size, and can, for example, range from seconds to several minutes or even to several hours in some embodiments.

According to an exemplary embodiment, a settling time, in other words the time for the pump system to reach a steady state, may be determined with a step response test. In such a test, a pressure that is known to be sufficient to satisfy the system demand is for example, used at the start. Then the pressure may be increased in a step-wise manner. As the control elements reduce the flow rate to the same flow rate as that acquired with the previous pressure, an estimate of the settling time can be calculated from the time domain change of the total flow rate.

For example, first, a pressure step may be introduced in to the system, causing a step-wise increase in the rotational speed and flow rate of the pump device. When the control elements begin to react to this pressure change by closing control valves, for example, in each branch to keep a constant flow rate, the pump rotational speed begins to decrease, as less rotational speed is needed to maintain the new pressure reference. Thus, the settling time of the constant pressure control in connection with the individual branch flow rate control elements is found and may be used as an execution time interval in the control method of the present solution as such or as a basis for the determination of the execution time interval. For example, the settling time can be determined as the time from the start of the step, in other words the pressure or rotational speed change, to the moment of time when the flow rate (estimate) has reached a value within 2 percent of its final value. It should be noted that the settling time may vary according to the system operating point, meaning for example that the settling time at lower total flow rates may differ from the settling time at higher total flow rates.

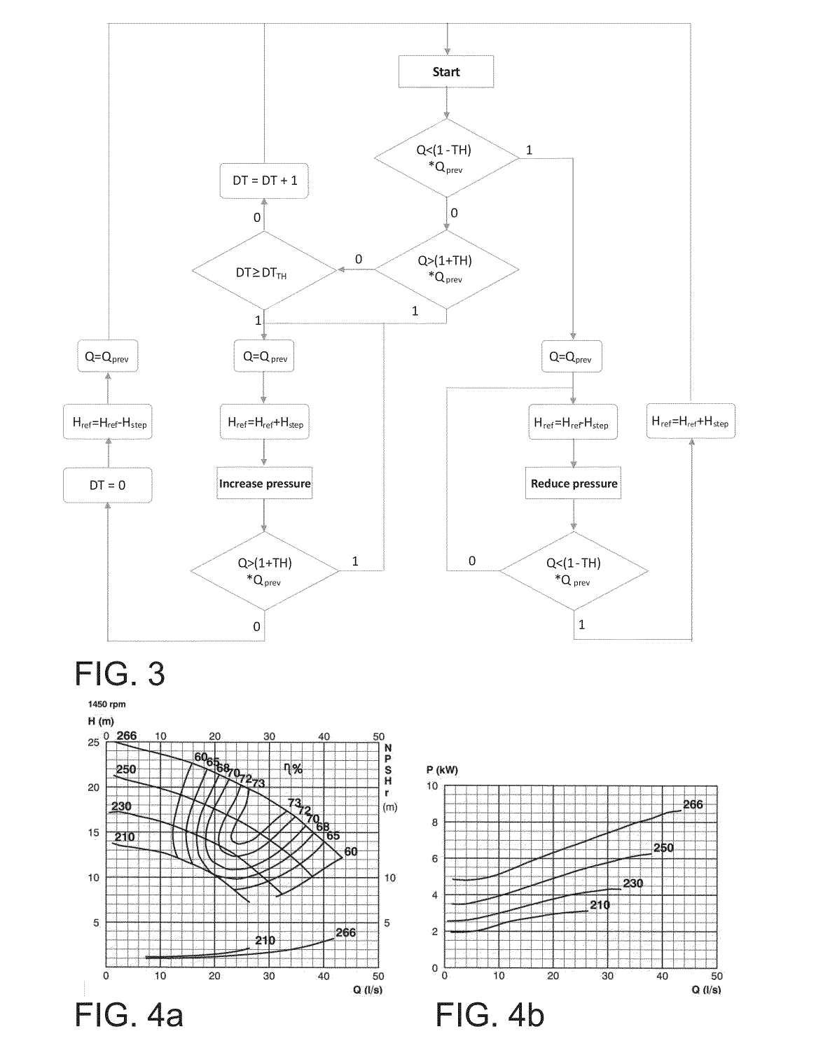

FIG. 3 schematically illustrates an exemplary embodiment of a method of controlling a pump system as a flow chart. This embodiment implements a control algorithm according to an exemplary embodiment of the present solution. According to this embodiment, the pump device may be controlled to a steady state by controlling the pump pressure, which is called a pressure reference H_{ref} in FIG. 3. The total flow rate Q may be measured and compared with a flow rate change threshold value. A pressure change may be introduced in response to the total flow rate exceeding the threshold value or a dead time threshold being reached.

In FIG. 3, DT refers to dead time loop index, DT_{TH} refers to a dead time threshold in loops to check the sufficiency of the pump pressure, Hₛₜₑₚ refers to a pressure change step, H_{ref} refers to a pressure reference, Q refers to a total flow rate, Qₚᵣₑᵥ refers to a total flow rate of the previous loop, and TH refers to a threshold for the flow rate as a relative value from 0 to 1.

According to an exemplary embodiment, a need for a pressure change may be determined in response to detection of a reduced flow rate. The current flow rate may then be saved as Qₚᵣₑᵥ and the pressure reference may be lowered by a predetermined pressure change step of the amount of Hₛₜₑₚ. The current pump flow rate Q, which can be measured when the system has again reached a steady state after the pressure change, may then be compared with the previous flow rate Qₚᵣₑᵥ according to the threshold criterion TH. In other words, it is checked whether the pressure change has caused a change in the total flow rate that exceeds the relative threshold value. These steps may be repeated to reduce the pump pressure in a step-wise manner until the pressure change results in a reduction in the flow rate. In other words, the pump pressure may be changed by a predetermined pressure step until a substantial change between a current pump flow rate Q and the previous total flow rate Qₚᵣₑᵥ is detected.

The change can be considered substantial when the relative threshold has been exceeded. When this happens, it can indicate that at that point the current pressure is lower than the lowest pressure that satisfies the demand. Thus, the pump device may be returned to the previous pump pressure value that is the pressure before the latest pressure changing step. Thus, a desired (e.g., optimal) pump pressure for the pump system in current operating conditions has been found and set and no further pressure change is needed until otherwise indicated. In FIG. 3, this branch or state is referred to as Reduce pressure.

According to an exemplary embodiment, a desire or need for a pressure change may be determined in response to detection of an increase in the total flow rate above the threshold value. Thus, the algorithm proceeds to the state referred to as Increase pressure. In this state, the pressure is increased step-wise until the total flow rate does not increase. At this point it is known that the previous pressure is, for example, a lowest pressure that satisfies the demand and it can be used as the pressure reference. In FIG. 3, this branch or state is referred to as Increase pressure.

According to an exemplary embodiment, the pump system may be configured to initiate a change in the pump pressure at predetermined time intervals equal to dead time threshold DT_{TH}. In other words, a desire or need for a pressure change may be determined in response to a time interval equal to dead time threshold having elapsed since a previous pump pressure change, when no recognizable change has been detected total flow rate during the time interval. For example, this pressure change can include increasing the pressure. This enables a sufficient pressure to be provided in a branch in which a valve has been fully opened because of an earlier pressure reduction, since at that point it cannot be known whether that particular branch requires more flow. A sufficient pressure in each of the branches can be ensured by testing regularly that the pressure remains at the specified (e.g., required) level in a manner similar to that disclosed above in connection with other embodiments. The dead time threshold should be greater than the execution time interval. According to an exemplary embodiment, the dead time threshold is equal to a multiple of the execution time interval.

An exemplary advantage of the present solution is that no additional instrumentation is needed, since model-based solutions can be used for the estimation of the flow rate and pressure of the pump device. A sensorless implementation can be based on model-based pump operating point estimation methods known per se. These estimation methods may include using pump device characteristic curves, such as the examples illustrated in FIGS. 4a and 4b, affinity laws known per se as a model of the pump device, and frequency converter estimates of the motor rotational speed and shaft power as inputs. The characteristics and general performance of a centrifugal pump, for example, can be visualized by characteristic curves for the pressure or head H, shaft power consumption P and efficiency η as a function of the flow rate Q at a constant rotational speed. The best efficiency point (BEP) of a centrifugal pump, in which the pump device should for example, be driven, is for example, also provided by the pump device manufacturer.

A frequency-converter-driven pump device, for example, can be operated at various rotational speeds and, thus, the pump device characteristic curves should be converted into the current rotational speed. This can be performed on the basis of flow rate, pump pressure, pump shaft power consumption and rotational speed utilizing affinity laws known per se. The pump device characteristic curves enable the sensorless estimation of the pump operating point location and efficiency by utilizing the rotational speed and shaft torque estimates (nₑₛₜ and Tₑₛₜ, respectively) available from a frequency converter in a manner known per se.

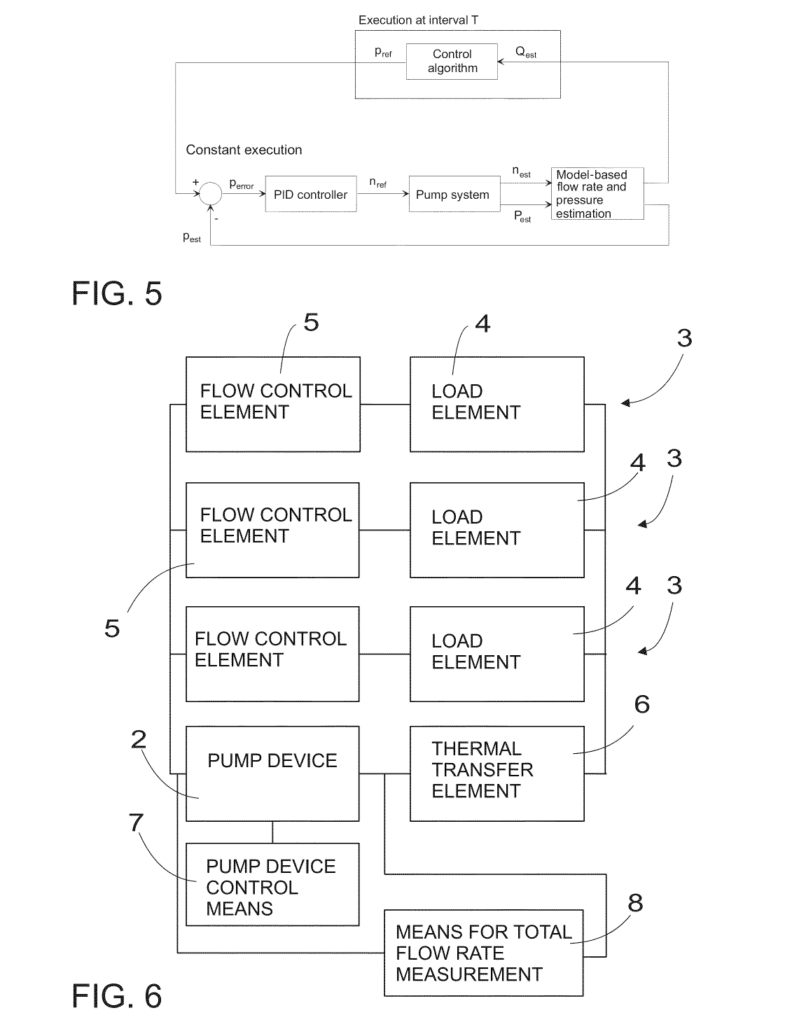

FIG. 5 schematically illustrates a block set diagram of a pump system control according to an exemplary embodiment of the present solution. In the illustrated control system, a control algorithm is executed at an execution time interval T. The execution time interval is for example, equal to or longer than the time needed for the pump system to reach a steady state after a previous pressure change. In other words, the execution time interval is for example, equal to or longer than the settling time. In the embodiment of FIG. 5, the pump device is constant pressure controlled during the operation. The constant pressure control may be executed constantly to ensure a constant pressure of the pump device such that an effect of an individual branch flow control element does not affect the pump pressure.

According to an exemplary embodiment, this constant pressure control can be achieved by a sensorless model-based operating point estimation method as presented in FIG. 5. In such a method, an error between a desired and the estimated pressure may be calculated and inputted to a PID controller. The PID controller may calculate a new rotational speed reference for the pump system. The frequency converter may then adjust the rotational speed and estimate the power, which may then be used to estimate the produced pressure and flow rate. The flow rate estimate can be used in the algorithm and the pressure estimate for control purposes in the constant pressure control as explained above.

According to an exemplary embodiment, the size of the predetermined pressure step or the step-wise change of the pressure reference Hₛₜₑₚ is related to the flow rate threshold TH. The flow rate threshold may be used to determine whether the total flow rate in the system has remained unchanged regardless of the change in the pressure. The pressure change step should for example, be selected to be such that it is able to produce a notable change in the system total flow rate.

FIG. 6 schematically illustrates an arrangement for pump system control. The pump system may include a pump device 2 and at least two branches 3 (three branches in the embodiment of FIG. 6), wherein each of the branches includes a flow control element 5. A flow control element may include a flow control valve, for example. According to an exemplary embodiment, the flow control element includes a thermostat.

A control arrangement for a pump system may include pump device control means 7 and means for measuring a total flow rate through a pump device 8. The pump device control means may be a frequency converter and/or a control unit, for example. Such frequency converters and control units are known per se. In different embodiments, these means may be arranged separately or some or all of the means may be integrated in the pump device. The means for measuring the total flow rate may be at least one sensor and/or control element, for example. Such sensors and control elements are known as such and in some embodiments a common control element may be used for both the pressure control and flow rate measurement.

The pump device control means may be configured to change the pump pressure by a predetermined pressure step and the means for measuring the total flow rate may be configured to measure the total flow rate before the pump pressure change and after the pump pressure change. The pump device control means may then further be configured to determine a desire or need for a further pump pressure change step on the basis of the total flow rate measurements before and after the pump pressure change. The pump device 2 may include a pump, a fan or a compressor. The pump system and/or the control arrangement may be used to implement one or more of the methods disclosed in this description or a combination thereof.

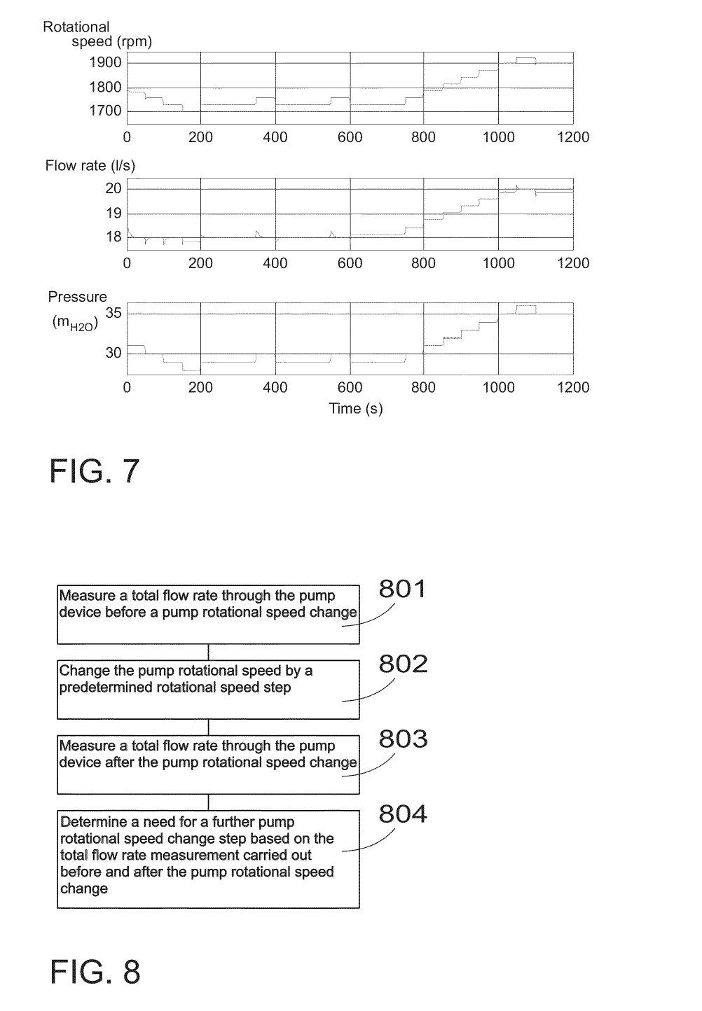

An example of a rotational speed, total flow rate and pressure in connection with a use case of pump system control is illustrated in FIG. 7. The pump system may include a three-branch pump system, wherein each of the branches includes an independent flow control element, such as a flow controlling valve, such as the embodiment of FIG. 1. In FIG. 7, the graphs start with the setup, in which the control valves are partially closed, the pump system is in balance and the execution time interval T is set at for example 50 seconds. A step-wise change in the flow rate specification (i.e., requirement) for a single branch occurs starting at the time instant of 600 s as a result of a change in the system specifications (i.e., requirements). The dead time threshold DT_{TH} has been set to be for example 150 s.

As the initial pressure has been found to be sufficient for the system, the system starts to change the pump pressure step-wise by a pressure change step. Between time instants of 0 to 200 seconds, the pressure reduces step by step. Between time instants of 0 to 150 seconds, the total flow rate remains approximately the same, as the system has reached a steady state. However, at time instants of 150 to 200 seconds, the total flow rate is notably reduced because of an insufficient pressure. Therefore, at 200 seconds the pressure is increased back to a sufficient level. This means that a lowest pressure for the system is found.

At time instants of 350 seconds and 550 seconds, on the basis of the dead time loop index, the algorithm checks whether a pressure increase is required, but since the total flow rate stays approximately the same despite the pressure increase, the pressure is not increased permanently. However, at 750 seconds the flow rate increases significantly when the pressure is increased, meaning that a higher pressure reference is required to satisfy the demand. The pressure is increased until the increase in the pressure does not increase the flow rate significantly. Again, the lowest pressure satisfying the demand is found.

For example, the system withstands some transients in the pressure and hence in the flow rate. Also, the system can withstand a certain amount of inaccuracy in the flow rate. For example, the settling time of the individual flow rate controls and pressure control should be faster than the change in the flow rate reference, whereby the flow rate demand would stay approximately constant during the pressure stepping.

FIG. 8 schematically illustrates a further exemplary method of controlling a pump device. In this method a total flow rate through the pump device is measured at 801 before a pump rotational speed change, the pump rotational speed is changed at 802 by a predetermined rotational speed step, a total flow rate through the pump device is measured at 803 after the pump rotational speed change, and a need for a further pump rotational speed change step is determined at 804 on the basis of the total flow rate measurement carried out before and after the pump rotational speed change. This exemplary embodiment may be similar to any one or any combination of the embodiments explained in connection with the control based on a pump pressure change in other respects, but instead of pressure change steps, the rotational speed change steps are used.

Similarly, any control arrangement explained in connection with the embodiments involving a pressure change step may be used in connection with a rotational speed change step as long as the pump device control means may be configured to change the rotational speed of the pump device.

According to an exemplary embodiment, a new rotational speed change step is only to be started once a sufficient time has elapsed since the previous rotational speed change step to enable the pump system to reach a steady state again. This time may also be referred to as an execution time interval and it should be defined separately for each system and embodiment because it can depend on the embodiment and system size, and it may for example range from seconds to several minutes or even to several hours in some embodiments, for example.

In different embodiments, the pump system may include a pump device 2, wherein the pump device 2 may include a pump, a fan or a compressor system or a combination thereof, wherein individual branch flow control elements are provided as long as allowed by the device and system characteristics. Correspondingly, the pump device 2 may include a pump, a fan or a compressor.

According to an exemplary embodiment, the current solution may be used in combination with the known solution of throttle control, when the system includes information on the valve setting of critical branches in the system. A combination of the both control methods can provide an even more precise flow control, which may be for example be beneficial in some applications. In such a case, the methods may be combined, which can lead to a situation where any system having flow rate control in a branch, whether it be known or unknown, can be enhanced (e.g., optimized). In such embodiments, additional sensors, such as pressure or flow rate sensors, may be provided for further improving the estimation accuracy of the model-based solutions for example, thus also improving the operation of the present solutions.

According to the present solution, the desired (e.g., required) pressure of a pump system and, thus, the dynamic flow losses of the system that has individual flow control elements in each branch can be reduced. The reduction in the flow resistances and the lower pressure can lead to a better energy efficiency. The implementation of the solution can be mainly carried out based on the model of the pump device with very little additional information needed. No information about the individual control elements is required, contrary to known solutions. On the other hand, the solution can be used along with the known solutions to, for example, ensure a pressure optimum in even more critical applications.

It will be apparent to those skilled in the art that, as technology advances, the inventive concepts can be implemented in various ways. The invention and its embodiments are not limited to the examples described above but may vary within the scope of the claims.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

1. A method of controlling a pump system having a pump device and at least two branches, wherein each of the branches has a flow control element, and a pump device control is provided in connection with the pump device, the method comprising:
measuring a total flow rate through the pump device before a pump pressure or rotational speed change;
changing at least one of: the pump pressure by a predetermined pressure step or the pump rotational speed by a predetermined rotational speed step;
measuring a total flow rate through the pump device after the pump pressure or rotational speed change; and
determining a need for a further pump pressure or rotational speed change step based on the total flow rate measurements carried out before and after the pump pressure or rotational speed change.

2. A method according to claim 1, wherein changing the pump pressure by a predetermined pressure step comprises:
lowering the pump pressure by a predetermined pressure step.

3. A method according to claim 1, comprising:
changing the pump pressure by lowering the pump pressure by a further predetermined pressure step in response to a total flow rate measurement value after a previous pump pressure change being substantially the same as a total flow rate measurement value before the previous pump pressure change.

4. A method according to claim 2, wherein a need for a pressure change is determined in response to detection of a reduced total flow rate.

5. A method according to claim 1, wherein changing the pump pressure by a predetermined pressure step comprises:
increasing the pump pressure by a predetermined pressure step.

6. A method according to claim 1, wherein a need for a pressure change is determined in response to detection of an increase in the total flow rate above a predetermined threshold value.

7. A method according to claim 1, wherein a further pressure change step is started in response to a time interval equal to a predetermined dead time threshold having elapsed since a previous pressure change step, wherein no recognizable pressure change has been detected.

8. A method according to claim 7, comprising:
determining a settling time with a step response test, wherein a pressure known to be sufficient to satisfy a system pressure demand is increased in a step-wise manner and the settling time is determined based on flow rate and pump rotational speed measurements.

9. A method according to claim 8, wherein the pump device is constant pressure controlled during operation.

10. A method according to claim 1, wherein the pump system comprises:
a pump system, a fan system or a compressor system.

11. A method according to claim 2, wherein the pump system comprises:
a pump system, a fan system or a compressor system.

12. A method according to claim 5, wherein the pump system comprises:
a pump system, a fan system or a compressor system.

13. A method according to claim 1, comprising:
controlling the pump system based on at least one of: control element valve settings and control element angle settings.

14. A control arrangement for a pump system having a pump device and at least two branches, wherein each branch has a flow control element, the control arrangement comprising:
means for measuring a total flow rate through a pump device, the means for measuring the total flow rate being configured to measure the total flow rate before a pump pressure or rotational speed change and after a pump pressure or rotational speed change; and
pump device control means, configured to change, by a predetermined step, at least one of pump pressure or pump rotational speed, the pump device control means being configured to determine a need for a further pump pressure or rotational speed change step based on said total flow rate measurements before and after a pump pressure or rotational speed.

15. The control arrangement according to claim 14, comprising:
additional sensors for detecting valve settings and angles of flow control elements.

16. The control arrangement according to claim 14, in combination with a pump system comprising:
a pump device; and
at least two branches, each having at least a flow control element.

17. The control arrangement according to claim 16, comprising:
additional sensors for detecting valve settings and angles of flow control elements.

18. The control arrangement according to claim 14, wherein the pump device comprises:
a pump, a fan or a compressor.

19. The control arrangement according to claim 15, wherein the pump device comprises:
a pump, a fan or a compressor.

20. The control arrangement according to claim 17, wherein the pump device comprises:
a pump, a fan or a compressor.
